(19) United States
(12) Patent Application Publication
(10) Pub. No.: US 2025/0026246 A1
(43) Pub. Date: Jan. 23, 2025

(54) SYSTEM AND APPARATUS SUITABLE FOR ADJUSTMENT OF ONE OR MORE SEATS, AND A PROCESSING METHOD IN ASSOCIATION THERETO

(71) Applicant: Continental Automotive Technologies GmbH, Hannover (DE)

(72) Inventor: Chieh Cheng (Kendra) Lai, Singapore (SG)

(73) Assignee: Continental Automotive Technologies GmbH, Hannover (DE)

(21) Appl. No.: 18/713,124

(22) PCT Filed: Sep. 29, 2022
(86) PCT No.: PCT/EP2022/077212

§ 371 Date: May 23, 2024

(30) Foreign Application Priority Data
Nov. 26, 2021 (GB) 2117060.0

(51) Int. Cl. B60N 2/02

(52) U.S. Cl. CPC B60N 2/0244

(57) ABSTRACT

A processing method for adjustment of at least one seat in a vehicle includes a preliminary adjustment step and a secondary adjustment. The preliminary adjustment step includes obtaining at least one preliminary sensory signal from at least one sensor positioned relative to the seat and generating at least one general control signal by determining a suitable seat adjustment model based on the preliminary sensory signal. The general control signal is communicable for use for preliminary adjustment of the seat. The secondary adjustment step includes obtaining at least one fine-tuning sensory signal from the sensor, determining delta data based on the fine-tuning sensory signal and the suitable seat adjustment model and generating at least one fine-tuning control signal based on the delta data. The fine-tuning control signal is communicable for use for secondary adjustment of the seat.

### FIELD OF INVENTION

The present disclosure generally relates to one or both of a system and an apparatus suitable for adjustment of one or more seats in, for example, an automobile. The present disclosure further relates a processing method associable to the system and/or the apparatus.

### BACKGROUND

Generally, a seat will have to be adjusted by a user manually for optimal user comfort. For example, in an automobile, a driver will typically need to adjust the driver seat to suit the driver's seating posture etc. for driving comfort.

However, there is a possibility that an automobile can be shared by a number of drivers and the driver's seat could need to be adjusted to suit individual drivers. This could be inefficient.

Moreover, there is a possibility that a driver may operate the automobile (e.g., drive the vehicle) without initially realizing that the driver seat has not been optimally adjusted. The driver may then be forced to drive under non-optimal conditions. Alternatively, the driver may then possibly attempt to adjust the seat whilst driving. This could be a potential safety risk as the driver may become distracted while driving.

The present disclosure contemplates that there is a need for improvement in regard to how a seat can be adjusted in, for example, an automobile.

### SUMMARY OF THE INVENTION

In accordance with an aspect of the disclosure, there is provided an apparatus which can be suitable for use for adjustment of one or more seats (e.g., a driver seat of a automobile). Adjustment of the seat can, for example, be based on a two-step adjustment strategy which can include a preliminary adjustment stage and a secondary adjustment stage.

The apparatus can include a first module and a second module, in one embodiment. In another embodiment, the apparatus can further include a third module.

The first module can, for example, be configured to receive one or more input signals. The input signal(s) can include one or more sensor signals and one or more general adjustment signals.

The sensor signal(s) can, for example, be communicated from one or more sensors which can be positioned relative to the apparatus. The general adjustment signal(s) can, for example, be communicated from one or more host devices which can be coupled to the apparatus.

The second module can be coupled to the first module. The second module can, for example, be configured to process the input signal(s) in a manner so as to produce one or more output signals.

The output signal(s) can, for example, include one or more preliminary derivation signals, one or more general control signals and one or more fine-tuning signal(s).

The preliminary derivation signal(s) can, for example, be based on processing of the sensor signal(s). The general control signal(s) can, for example, be based on the general adjustment signal(s). Moreover, the general control signal(s) can be used in association with the preliminary adjustment stage of the seat(s). Furthermore, the fine-tuning control signal(s) can be used in association with the secondary adjustment stage of the seat(s). The fine-tuning control signal(s) can, for example, be based on receiving one or more sensor signals which can be communicated from the sensor(s) subsequent to the preliminary adjustment stage.

In one embodiment, the sensor signal(s) can include one or more preliminary sensory signals and one or more fine-tuning sensory signals. The preliminary sensory signal(s) can be associated with the preliminary adjustment stage whereas the fine-tuning sensory signal(s) can be associated with the secondary adjustment stage.

It is contemplated that the second module can be configured to process the preliminary sensory signal(s) in a manner so as to generate the preliminary derivation signal(s). The preliminary derivation signal(s) can be processed in a manner so as to obtain a suitable seat adjustment model. The general adjustment signal(s) can, for example, be based on the suitable seat adjustment model. Moreover, the sensor signal(s) communicable from the sensor(s) subsequent to the preliminary adjustment stage can, for example, correspond to the fine-tuning sensory signal(s).

It is further contemplated that the suitable seat adjustment model can, for example, be associated with one or more threshold values and the fine-tuning sensory signal(s) can, for example, be associated with real-time user data. The apparatus can, in one embodiment, be configured to process the real-time user data and the threshold value(s) in a manner so as to derive delta data for use in association with secondary adjustment of the seat(s).

In one embodiment, the real-time user data can include a plurality of portions. Based on processing of the real-time user data and the threshold value(s) by the apparatus, one or more portions of the real-time user data can be determined to be either optimal or non-optimal. It is contemplated that delta data can be based only on non-optimal portions of the real-time user data.

As mentioned earlier, real-time user data required for further processing for the purpose of generating the requisite fine-tuning control signal(s) can effectively be considered to be streamlined/trimmed. In this manner, efficient processing can be facilitated. Moreover, since real-time user data required for further processing can effectively be streamlined/trimmed (i.e., not the entire real-time user data need to be considered for further processing), the present disclosure further contemplates that adjustment can be completed in a more time-efficient manner.

Further mentioned earlier, the apparatus can further include a third module, in accordance with an embodiment of the disclosure. The third module can, for example, be coupled to the second module. The output signal(s) can be communicated to the third module from the second module for further transmission from the apparatus for further processing so as to determine a suitable seat adjustment model usable for the preliminary adjustment stage of the seat(s). The suitable seat adjustment model can, for example, be determined based on the preliminary derivation signal(s) and the general adjustment signal(s) can be determined based on the suitable seat adjustment model. Moreover, the suitable seat adjustment model can be associated with one or more threshold values and the sensor(s) can be configured to communicate one or more fine-tuning sensory signal(s) obtained subsequent to the preliminary adjustment stage. The fine-tuning sensory signal(s) can be associated with real-time user data. The apparatus can be configured to process the real-time user data and the threshold value(s) to derive delta data for use for secondary adjustment of the seat(s). Moreover, based on processing of the real-time user data and the threshold value(s) by the apparatus, one or more portions of the real-time user data can be determined to be either optimal or non-optimal. It is contemplated that delta data can, for example, be based only on non-optimal portions of the real-time user data. It is further contemplated that there is a possibility that the output signal(s) can, for example, be received by the host device(s) for machine-learning based processing.

As mentioned earlier, real-time user data required for further processing for the purpose of generating the requisite fine-tuning control signal(s) can effectively be considered to be streamlined/trimmed. In this manner, efficient processing can be facilitated. Moreover, since real-time user data required for further processing can effectively be streamlined/trimmed (i.e., not the entire real-time user data need to be considered for further processing), the present disclosure further contemplates that adjustment can be completed in a more time-efficient manner.

The above-described advantageous aspect(s) of the apparatus of the present disclosure can also apply analogously (all) the aspect(s) of a below described processing method of the present disclosure. Likewise, all below described advantageous aspect(s) of the processing method of the disclosure can also apply analogously (all) the aspect(s) of above described apparatus of the disclosure.

In accordance with another aspect of the disclosure, there is provided a processing method which can be suitable for adjustment of one or more seats (e.g., one or more seats in a vehicle).

The processing method can include a preliminary adjustment step and a secondary adjustment step.

The preliminary adjustment step can include:
obtaining one or more preliminary sensory signals from one or more sensors positioned relative to the seat(s)
generating one or more general control signals by manner of determining a suitable seat adjustment model based on the preliminary sensory signal(s)

The general control signal(s) can be communicated for use for preliminary adjustment of the seat(s).

For example, the preliminary sensory signal(s) can be received by the first module of the aforementioned apparatus and the general control signal(s) can be generated by the second module of the aforementioned apparatus, in accordance with an embodiment of the disclosure.

The secondary adjustment step can include:
obtaining one or more fine-tuning sensory signals from the sensor(s)
determining delta data based on the fine-tuning sensory signal(s) and the suitable seat adjustment model
generating one or more fine-tuning control signals based on the delta data

The fine-tuning control signal(s) can be communicated for use for secondary adjustment of the seat(s).

For example, the fine-tuning sensory signal(s) can be received by the first module of the aforementioned apparatus, the delta data can be determined by the second module of the aforementioned apparatus and the fine-tuning control signal(s) can be generated by the second module of the aforementioned apparatus, in accordance with an embodiment of the disclosure.

In one embodiment, the suitable seat adjustment model can be associated with one or more threshold values. The sensor(s) can be configured to communicate one or more fine-tuning sensory signals obtained subsequent to the preliminary adjustment stage. The fine-tuning sensory signal(s) can be associated with real-time user data. Moreover, the real-time user data and the threshold value(s) can be processed to derive delta data for use for secondary adjustment of the seat(s). It is contemplated that one or more portions of the real-time user data can be determined to be either optimal or non-optimal. It is further contemplated that delta data can, for example, be based only on the non-optimal portion(s) of the real-time user data.

The present disclosure further contemplates a computer program (not shown) which can include instructions which, when the program is executed by a computer (not shown), cause the computer to carry out the preliminary adjustment step and the secondary adjustment step as discussed with reference to the processing method.

The present disclosure yet further contemplates a computer readable storage medium (not shown) having data stored therein representing software executable by a computer (not shown), the software including instructions, when executed by the computer, to carry out the preliminary adjustment step and the secondary adjustment step as discussed with reference to the processing method.

As mentioned earlier, real-time user data required for further processing for the purpose of generating the requisite fine-tuning control signal(s) can effectively be considered to be streamlined/trimmed. In this manner, efficient processing can be facilitated. Moreover, since real-time user data required for further processing can effectively be streamlined/trimmed (i.e., not the entire real-time user data need to be considered for further processing), the present disclosure further contemplates that adjustment can be completed in a more time-efficient manner.

### BRIEF DESCRIPTION OF THE DRAWINGS

Embodiments of the disclosure are described hereinafter with reference to the following drawings, in which:

FIG. 1 shows a system which can include at least one apparatus, according to an embodiment of the disclosure;

FIG. 2 shows the apparatus of FIG. 1 in further detail, according to an embodiment of the disclosure;

FIG. 3 shows a processing method in association with the system of FIG. 1, according to an embodiment of the disclosure;

FIG. 4 shows an example flow diagram in association with the processing method of FIG. 3, according to an embodiment of the disclosure; and

FIG. 5a and FIG. 5b respectively show, in association with the example flow diagram of FIG. 4, an example scenario in connection with a seat adjustment sequence and a driver seated on a driver's seat of an automobile, according to an embodiment of the disclosure.

### DETAILED DESCRIPTION

The present disclosure contemplates that a two-stage adjustment mechanism/strategy of seat(s) (e.g., seat(s) in an automobile) can be useful. Particularly, the present disclosure contemplates the possibility of facilitating efficiency (e.g., processing efficiency and/or time-efficient) by manner of trimming/streamlining real-time user data required for processing.

Generally, the two-stage adjustment mechanism/strategy can include a first adjustment stage (e.g., a preliminary adjustment stage/step) and a second adjustment stage (e.g., a secondary adjustment stage/step).

The first adjustment stage can be based on a general adjustment model (i.e., which will be referred to as a suitable seat adjustment model hereinafter). The second adjustment stage can be based on, for example, a fine-tuned form of adjustment (as will be discussed later in the context of fine-tuning control signal(s)) subsequent to the first adjustment stage.

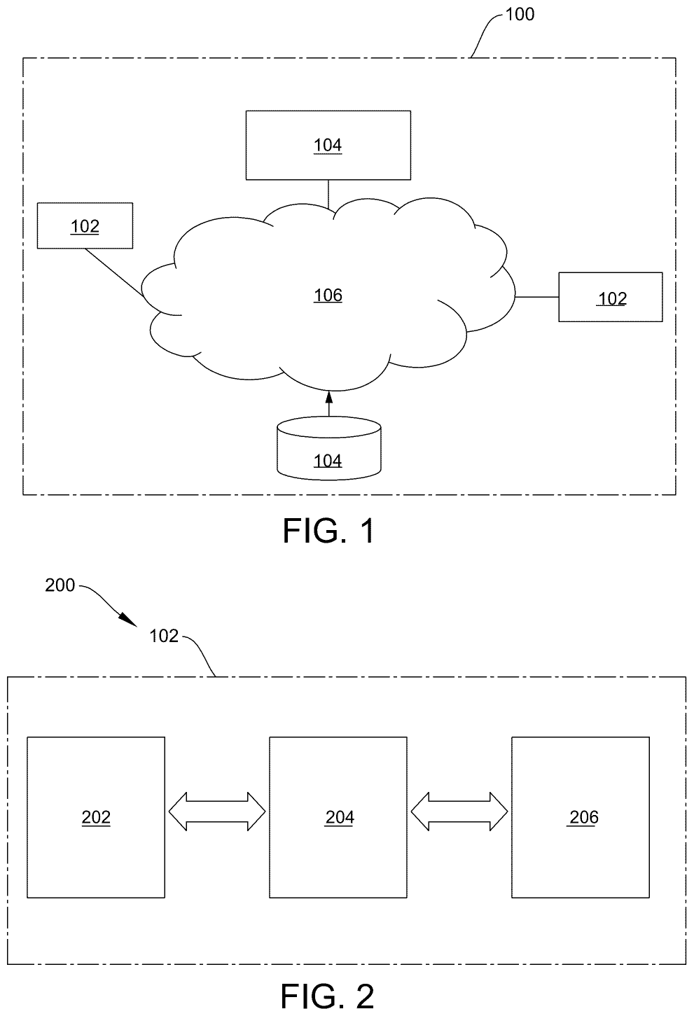

The foregoing will be discussed in further detail with reference to FIG. 1 to FIG. 5 hereinafter.

Referring to FIG. 1, a system 100 is shown, according to an embodiment of the disclosure. The system 100 can be suitable for adjustment of at least one seat (not shown). For example, the system 100 can be suitable for adjustment of one or more seats in association with a vehicle (e.g., an automobile).

In one embodiment, the system 100 can, for example, correspond to an electronic-based system which can be at least partially carried (e.g., the system being installed) by a, for example, vehicle (not shown). In one example, the system 100 can be fully (i.e., the entire system 100) carried by a vehicle. In another example, one or more portions of the system 100 can be carried by a vehicle whereas another one or more portions of the system 100 can be carried outside of the vehicle (e.g., at least one portion of the system 100 is not carried by the vehicle).

The system 100 can include one or more apparatuses 102, at least one device 104 and, optionally, a communication network 106, in accordance with an embodiment of the disclosure. In one embodiment, the system 100 can further include one or more host devices (not shown).

The apparatus(es) 102 can be coupled to the device(s) 104. Specifically, the apparatus(es) 102 can, for example, be coupled to the device(s) 104 via the communication network 106. The host device(s) can, for example, be coupled to one or both of the apparatus(es) 102 and the device(s) 104. Specifically, the host device(s) can, for example, be coupled to the apparatus(es) 102 and/or the device(s) 104 via the communication network 106.

In one embodiment, the apparatus(es) 102 can be coupled to the communication network 106 and the device(s) 104 can be coupled to the communication network 106. Moreover, in one embodiment, the host device(s) can be coupled to the communication network 106. Coupling can be by manner of one or both of wired coupling and wireless coupling.

The apparatus(es) 102 can, in general, be configured to communicate with the device(s) 104 via the communication network 106, according to an embodiment of the disclosure. The host device(s) can, in general, be configured to communicate with the apparatus(es) 102 and/or the device(s) 104 via the communication network 106, according to an embodiment of the disclosure.

The apparatus(es) 102 can, for example, correspond to one or more computers (e.g., an electronic device/module having computing capabilities such as an electronic mobile device which can be carried into a vehicle or an electronic module which can be installed in a vehicle). The apparatus(es) 102 can, in one embodiment, include one or more processors (not shown) which can be configured to perform one or more processing tasks. Generally, the apparatus(es) 102 can be configured to generate and/or receive one or more input signals and process the input signal(s) in a manner so as to produce one or more output signals. The apparatus(es) 102 will be discussed later in further detail with reference to FIG. 2, according to an embodiment of the disclosure.

The device(s) 104 can, for example, include one or both of at least one sensor and at least one electro-mechanical control device. Specifically, the device(s) 104 can include one or more sensors and/or one or more electro-mechanical control devices, in accordance with an embodiment of the disclosure. In one example, the sensor(s) and/or the electro-mechanical control device(s) can be coupled to the apparatus(s) 102. In another example, the sensor(s) can be coupled to the electro-mechanical control device(s).

The sensor(s) can be carried by a vehicle (e.g., carried within the vehicle) and can be configured to obtain data associated with one or more users of the vehicle. The user(s) can, for example, include a driver/operator or the vehicle and/or one or more passengers, in accordance with an embodiment of the disclosure. In one embodiment, the sensor(s) can be configured to obtain data associated with, for example, a driver/an operator of the vehicle. The obtained data can, for example, be communicated from the sensor(s) to the apparatus(es) 102 for processing. For example, the sensor(s) can be configured to communicate one or more sensor signals corresponding to the obtained data to the apparatus(es) 102 for processing. Examples of data associated with the user(s) of the vehicle can include body temperature (e.g., body temperature of the driver/operator), field of view (e.g., visual perception of the driver/operator through the windscreen of the vehicle), weight (e.g., body weight of the driver/operator) or any combination thereof. The present disclosure contemplates the possibility that the sensor(s), which can be positioned at various positions in association with the vehicle, can be utilized to construct a three-dimensional (3D) image view.

The electro-mechanical control device(s) can be carried by the seat(s) (e.g., the seat(s) can be installed with the electronic-mechanical control device(s)) in a vehicle. The electro-mechanical control device(s) can be configured to receive the output signal(s) from the apparatus(es) 102 and adjust the seat(s) accordingly, in accordance with an embodiment of the disclosure. This will be discussed later in further detail.

The host device(s) (e.g., one or more computers or one or more databases) can, for example, be configured to host/carry a platform (software and/or hardware platform) configured to perform one or more processing tasks which can, for example, include learning-based processing tasks (e.g., machine-learning based processing). The host device(s) can be further configured to carry one or more data sets corresponding to one or more models (e.g., seat adjustment models). Such model(s) can correspond to, in one example, publicly available dataset(s) associated with parameters in connection with characteristics (e.g., body weight and/or body temperature) of user(s) and sitting positions (e.g., pressure data and/or field of view data) of user(s). Such model(s) can correspond to, in another example, previously learnt and stored (e.g., proprietary information which may or may not be made publicly available) dataset(s) associated with parameters in connection with characteristics (e.g., body weight and/or body temperature) of user(s) and sitting positions (e.g., pressure data and/or field of view data) of user(s). Such model(s) can correspond to, in yet another example, a combination of publicly available dataset(s) and proprietary information. A suitable seat adjustment model can be obtained from the model(s) and one or more general adjustment signals can be communicated from the host device(s) to, for example, the apparatus(es) 102 for further processing.

The communication network 106 can, for example, correspond to an Internet communication network, a wired-based communication network, a wireless-based communication network, or any combination thereof. Communication (i.e., between the apparatus(es) 102 and the device(s) 104) via the communication network 106 can be by manner of one or both of wired communication and wireless communication.

Earlier mentioned, the apparatus(es) 102 can be configured to generate and/or receive one or more input signals and process the input signal(s) in a manner so as to produce one or more output signals. The device(s) 104 (e.g., the aforementioned electro-mechanical control device(s)) can be configured to receive the output signal(s) from the apparatus(es) 102 and adjust the seat(s) accordingly, according to an embodiment of the disclosure. This will be discussed in further detail in the context of an example implementation hereinafter.

Generally, the present disclosure contemplates that the input signals can be received by the apparatus(es) 102 and processed to produce the output signal(s).

The input signals can include/be based on one or both of the sensor signal(s) and the general adjustment signal(s). In one embodiment, the input signal(s) can include/be based on only the sensor signal(s). In another embodiment, the input signal(s) can include/be based on only the general adjustment signal(s). In yet another embodiment, the input signal(s) can include/be based on both the sensor signal(s) and the general adjustment signal(s).

In the example implementation, the input signal(s) can include/be based on both the sensor signal(s) and the general adjustment signal(s). Moreover, the sensor signal(s) can include one or both of at least one preliminary sensory signal and at least one fine-tuning sensory signal. In one example, the sensor signal(s) can include one or more preliminary sensory signals and one or more fine-tuning sensory signals. Furthermore, the output signal(s) can include one or both of at least one general control signal and at least one fine-tuning control signal. In one example, the output signal(s) can include one or more general control signals and one or more fine-tuning control signals.

A suitable seat adjustment model can be derived based on, for example, the aforementioned preliminary sensory signal(s). For example, based on the preliminary sensory signal(s), the apparatus(es) 102 can be configured to generate and communicate one or more preliminary derivation signals to the host device(s). In this regard, it is appreciable that the aforementioned output signal(s) can further include/be based on the preliminary derivation signal(s), in accordance with an embodiment of the disclosure. Based on the preliminary derivation signal(s), at least one suitable seat adjustment model can be selected (i.e., from the data set(s)). In one embodiment, the suitable seat adjustment model(s) can be selected by manner of machine learning (ML)-based processing. For example, a ML model (Decision Tree) can be utilized for the purpose of selecting the suitable seat adjustment model(s) and preliminary derivation signal(s) can be run through the ML model (Decision Tree) to select the suitable seat adjustment model(s). At least one general adjustment signal corresponding to the selected seat adjustment model(s) can be communicated from the host device(s) to the apparatus(es) 102 for processing to generate the general control signal(s).

The general control signal(s) can be communicated to the device(s) 104 to adjust the seat(s) in a general manner (i.e., general adjustment of the seat(s)). Specifically, the general control signal(s) can be communicated to the electro-mechanical control device(s) and based on the general control signal(s), the electro-mechanical control device(s) can be configured to perform a general adjustment of the seat(s). The general adjustment of the seat(s) can also be referred to as a preliminary adjustment of the seat(s). Subsequent to the general adjustment of the seat(s), the sensor(s) can be configured to generate and communicate the fine-tuning sensory signal(s) to the apparatus(es) 102 for further processing to generate the fine-tuning control signal(s). The fine-tuning control signal(s) can be communicated to the electro-mechanical control device(s) and based on the fine-tuning control signal(s), the electro-mechanical control device(s) can be configured to perform a fine adjustment of the seat(s). The fine adjustment of the seat(s) can also be referred to as a secondary adjustment (i.e., subsequent to the preliminary adjustment) of the seat(s).

For example, a driver/operator seat of a vehicle can be adjusted based on the above discussed manner. When a driver/operator initially seats in the vehicle (i.e., seated on the driver/operator seat) and starts the engine of the vehicle, the preliminary sensory signal(s) can be obtained based on, for example, data (e.g., body weight, body temperature, seat back position, field of view, or any combination thereof) associated with the driver/operator. Preliminary adjustment of the driver/operator seat can then be performed based on the preliminary sensory signal(s) as discussed earlier. After preliminary adjustment has been completed, the sensor(s) can be configured to generate and communicate the fine-tuning sensory signal(s). Specifically, the fine-tuning sensory signal(s) can be obtained based on, for example, data (e.g., body weight, body temperature, seat back position, field of view, or any combination thereof) associated with the driver/operator, whilst seated, subsequent to the preliminary adjustment of the driver/operator seat. It is contemplated that seating position may possibly not be optimal even after preliminary adjustment has been completed.

In one example, the field of view of the driver/operator through the windscreen may not be optimal (e.g., the sensor(s) can be configured to obtain data concerning the driver's/operator's eye level relative to a position on the windscreen). The present disclosure contemplates that, in one embodiment, the aforementioned suitable seat adjustment model can be associated with a threshold value in connection with optimal field of view. After preliminary adjustment, data concerning the eye level of the operator/driver (whilst seated) relative to the windscreen can be obtained and communicated from the sensor(s). In this regard, it is appreciable that real-time data concerning the eye level of the operator/driver (i.e., also referable to as real-time user data) can be compared against the threshold value and any deviation (i.e., deviation between the real-time user data and the threshold value can be computed to derive delta data for use for secondary adjustment of the driver/operator seat.

In another example, the resting position of the driver's/operator's foot on the vehicle pedal (e.g., brake pedal/accelerator pedal) may not be optimal (e.g., the sensor(s) can be configured to obtain pressure-based data in connection with the driver's/operator's foot on the vehicle pedal). The present disclosure contemplates that, in one embodiment, the aforementioned suitable seat adjustment model can be associated with a threshold value in connection with foot contact pressure relative to the vehicle pedal. After preliminary adjustment, data concerning the foot contact of the operator/driver (whilst seated) relative to the vehicle pedal can be obtained and communicated from the sensor(s). In this regard, it is appreciable that real-time data concerning the contact pressure of the foot of the operator/driver (i.e., also referable to as real-time user data) can be compared against the threshold value and any deviation (i.e., deviation between the real-time user data and the threshold value(s) can be computed to derive delta data for use for secondary adjustment of the driver/operator seat. In this regard, processing can, for example, be by manner of comparative-based processing (e.g., the real-time user data and the threshold value(s) can be processed by manner of comparison so as to derive delta data).

In the context of the above examples, it is appreciable that the fine-tuning sensory signal(s) can include/correspond to real-time user data (i.e., obtained after the preliminary adjustment). Such real-time user data can, for example, be associated with one or both of field of view data (e.g., eye level relative to the windscreen) and contact pressure data (e.g., foot contact pressure on the vehicle pedal).

In one embodiment, the fine-tuning sensory signal(s) can be communicated from the sensor(s) to the apparatus(es) 102 for processing to derive the delta data. Based on the derived delta data, the apparatus(es) 102 can be configured to generate the fine-tuning control signal(s).

In another embodiment, the fine-tuning sensory signal(s) can be communicated from the sensor(s) to the host device(s) for processing to derive the delta data. The derived delta data can be further communicated from the host device(s) to the apparatus(es) 102 for further processing to generate the fine-tuning control signal(s).

In yet another embodiment, the fine-tuning sensory signal(s) can be communicated from the sensor(s) to both the apparatus(es) 102 and the host device(s) for processing to derive the delta data. Based on the derived delta data, the apparatus(es) 102 can be configured to generate the fine-tuning control signal(s).

Earlier mentioned, the fine-tuning control signal(s) can be communicated (e.g., from the apparatus(es) 102) to the electro-mechanical device(s) for the secondary adjustment of the driver/operator seat.

The present disclosure contemplates that, for example, if, after the preliminary adjustment, one or more portions of the real-time user data can already be considered to be optimal (i.e., within the relevant threshold value(s)), those portions of the real-time user data can effectively be omitted from further consideration for the purpose of generating the fine-tuning control signal(s). Such portion(s) of the real-time user data need not be further processed for the purpose of generating the fine-tuning control signal(s). Only portion(s) of the real-time user data not considered to be optimal (i.e., not within the relevant threshold value(s)) should be considered for the purpose of generating the fine-tuning control signal(s). Specifically, it is contemplated that each portion of the real-time user data can be associated with a parameter and parameters already considered to be optimal need not be considered for further processing whereas parameters which are not considered to be optimal need to be considered for further processing. The aforementioned field of view data (e.g., eye-level of the driver/operator relative to the windscreen) and the aforementioned pressure-based data (e.g., in connection with the driver's/operator's foot on the vehicle pedal) are examples of parameters.

For example, where the real-time user data include a first parameter (e.g., the aforementioned field of view data) and a second parameter (e.g., the aforementioned pressure-based data), and the first parameter can be considered to already be optimal (i.e., the field of view data can be considered to be within the threshold value) whereas the second parameter is not considered to be optimal, the first parameter can be omitted from consideration/further processing and the fine-tuning control signal(s) can be based only on the second parameter.

It is appreciable that the present disclosure generally contemplates, for example, a two-stage adjustment mechanism/strategy of seat(s) (e.g., seat(s) in a vehicle), in accordance with an embodiment of the disclosure. The two-stage adjustment mechanism/strategy of seat(s) can, for example, include a first-stage adjustment (of seat(s))) and a second-stage adjustment (of seat(s)). The first-stage adjustment can include the aforementioned preliminary adjustment and the second-stage adjustment can include the aforementioned secondary adjustment. The two-stage adjustment mechanism/strategy of seat(s) can simply be referred to as two-stage adjustment.

The present disclosure contemplates that by manner of the above two-stage adjustment, user experience can be improved (e.g., adjustment to attain a more comfortable seating position) in an efficient manner. In particular, by manner of preliminary general adjustment (i.e., the first-stage adjustment) followed by a fine-tuned adjustment (i.e., second-stage adjustment), processing efficiency can be improved. After preliminary general adjustment (based on a suitable seat adjustment model which can be generally made available via the host device(s)), the present disclosure contemplates the possibility that one or more parameters need not be adjusted and can be omitted from further processing to generate the requisite fine-tuning control signal(s). Therefore, it is appreciable that there is a possibility that not all portions of the real-time user data need to be processed and only certain portions (i.e., associated with parameters not considered to be optimal) of the real-time user data need to be considered for further processing for the purpose of generating the requisite fine-tuning control signal(s). Effectively, real-time user data required for further processing for the purpose of generating the requisite fine-tuning control signal(s) can be considered to be streamlined/trimmed. In this manner efficient processing can be facilitated. Moreover, since real-time user data required for further processing can effectively be streamlined/trimmed (i.e., not the entire real-time user data need to be considered for further processing), the present disclosure further contemplates that adjustment can be completed in a more time-efficient manner.

The present disclosure further contemplates that after the two-stage adjustment, the adjusted parameters (i.e., based on the two-stage adjustment) can be the basis of a new model customized for a specific user and such a new model can be stored for future use/reference. For example, such a new model can be included as part of the aforementioned one or more data sets carried by the host device(s) (i.e. such a new model can be stored by the host device(s)). In this manner, such a new model can be utilized during the first-stage adjustment in future for the same user and a second-stage adjustment may potentially be omitted. Therefore, further efficiency can be facilitated.

The aforementioned apparatus(es) 102 will be discussed in further detail with reference to FIG. 2 hereinafter.

Referring to FIG. 2, an apparatus 102 is shown in further detail in the context of an exemplary implementation 200, according to an embodiment of the disclosure.

In the exemplary implementation 200, the apparatus 102 can carry any one of a first module 202, a second module 204, a third module 206, or any combination thereof.

In one embodiment, the apparatus 102 can carry a first module 202, a second module 204 and, optionally, a third module 206.

The first module 202 can be coupled to one or both of the second module 204 and the third module 206. The second module 204 can be coupled to one or both of the first module 202 and the third module 206. The third module 206 can be coupled to one or both of the first module 202 and the second module 204. Coupling between the first, second and/or third modules 202/204/206 can, for example, be by manner of one or both of wired coupling and wireless coupling. Each of the first, second and third modules 202/204/206 can correspond to one or both of a hardware-based module and a software-based module, according to an embodiment of the disclosure.

In one example, the first module 202 can correspond to a hardware-based receiver which can be configured to receive the input signal(s). In another example, the first module 202 can correspond to a graphics user interface (e.g., displayable on a screen, which is not shown, of the apparatus(es) 102) usable by a user (not shown) for generating one or more command signals which can, in turn, generate the input signal(s). Generally, the first module 202 can be associated with data acquisition (i.e., acquired data corresponding to the input signal(s)). This will be discussed later in further detail.

The second module 204 can, for example, correspond to a hardware-based processor which can be configured to perform one or more processing tasks based on the input signal(s) to produce one or more output signals.

The third module 206 can correspond to a hardware-based transmitter which can be configured to transmit the output signal(s).

The present disclosure contemplates the possibility that the first and third modules 202/206 can be an integrated software-based transceiver module (e.g., an electronic part which can carry a software program/algorithm in association with receiving and transmitting functions/an electronic module programmed to perform the functions of receiving and transmitting). Moreover, it is appreciable that the aforementioned graphics user interface can be considered to be software-based.

Earlier mentioned, the first module 202 can be associated with data acquisition. Additionally, the second module 204 can, for example, correspond to a hardware-based processor which can be configured to perform one or more one or more processing tasks on the received and/or generated input signal(s) to produce one or more output signals.

In one example implementation, the first module 202 can correspond to a hardware-based receiver which can be configured to receive the aforementioned input signal(s) communicated from one or both of the device(s) 104 and the host device(s). For example, the input signal(s) can be communicated of the sensor(s) and/or the host device(s). Sensor signal(s) can be communicated from the sensor(s) and general adjustment signal(s) can be communicated from the host device(s). The third module can correspond to a hardware-based transmitter configured to communicate the output signal(s) from the apparatus 102. The output signal(s) can be communicated to one or both of the device(s) 104 (e.g., communication of the general control signal(s) and/or the fine-tuning control signal(s) to the electro-mechanical device(s)) and the host device(s) (e.g., communication of the preliminary derivation signal(s)).

In view of the foregoing, it is appreciable that the present disclosure can generally relate to an apparatus 102 suitable for use for adjustment of one or more seats of, for example, an automobile. For example, the apparatus 102 can be suitable for use for adjustment of one or more vehicle seats (e.g., seat of a driver/operator of the vehicle). In a more specific example, the apparatus 102 can be suitable for use for adjustment of a driver seat.

Specifically, the present disclosure contemplates, according to an embodiment, an apparatus 102 which can be suitable for use for adjustment of one or more seats (e.g., a driver seat of a automobile). Adjustment of the seat can, for example, be based on a two-step adjustment strategy which can include a preliminary adjustment stage and a secondary adjustment stage.

The apparatus 102 can include a first module 202 and a second module 204, in one embodiment. In another embodiment, the apparatus 102 can further include a third module 206.

The first module 202 can, for example, be configured to receive one or more input signals. The input signal(s) can include one or more sensor signals and one or more general adjustment signals.

The sensor signal(s) can, for example, be communicated from one or more sensors which can be positioned relative to the apparatus 102. The general adjustment signal(s) can, for example, be communicated from one or more host devices which can be coupled to the apparatus 102.

The second module 204 can be coupled to the first module 202. The second module 204 can, for example, be configured to process the input signal(s) in a manner so as to produce one or more output signals.

The output signal(s) can, for example, include one or more preliminary derivation signals, one or more general control signals and one or more fine-tuning signal(s).

The preliminary derivation signal(s) can, for example, be based on processing of the sensor signal(s). The general control signal(s) can, for example, be based on the general adjustment signal(s). Moreover, the general control signal(s) can be used in association with the preliminary adjustment stage of the seat(s). Furthermore, the fine-tuning control signal(s) can be used in association with the secondary adjustment stage of the seat(s). The fine-tuning control signal(s) can, for example, be based on receiving one or more sensor signals which can be communicated from the sensor(s) subsequent to the preliminary adjustment stage.

In one embodiment, the sensor signal(s) can include one or more preliminary sensory signals and one or more fine-tuning sensory signals. The preliminary sensory signal(s) can be associated with the preliminary adjustment stage whereas the fine-tuning sensory signal(s) can be associated with the secondary adjustment stage.

It is contemplated that the second module 204 can be configured to process the preliminary sensory signal(s) in a manner so as to generate the preliminary derivation signal(s). The preliminary derivation signal(s) can be processed in a manner so as to obtain a suitable seat adjustment model. The general adjustment signal(s) can, for example, be based on the suitable seat adjustment model.

Moreover, the sensor signal(s) communicable from the sensor(s) subsequent to the preliminary adjustment stage can, for example, correspond to the fine-tuning sensory signal(s).

It is further contemplated that the suitable seat adjustment model can, for example, be associated with one or more threshold values and the fine-tuning sensory signal(s) can, for example, be associated with real-time user data. The apparatus 102 can, in one embodiment, be configured to process the real-time user data and the threshold value(s) in a manner so as to derive delta data for use in association with secondary adjustment of the seat(s).

In one embodiment, the real-time user data can include a plurality of portions. Based on processing of the real-time user data and the threshold value(s) by the apparatus 102, one or more portions of the real-time user data can be determined to be either optimal or non-optimal. It is contemplated that delta data can be based only on non-optimal portions of the real-time user data.

As mentioned earlier, real-time user data required for further processing for the purpose of generating the requisite fine-tuning control signal(s) can effectively be considered to be streamlined/trimmed. In this manner, efficient processing can be facilitated. Moreover, since real-time user data required for further processing can effectively be streamlined/trimmed (i.e., not the entire real-time user data need to be considered for further processing), the present disclosure further contemplates that adjustment can be completed in a more time-efficient manner.

Further mentioned earlier, the apparatus 102 can further include a third module 206, in accordance with an embodiment of the disclosure. The third module 206 can, for example, be coupled to the second module 204. The output signal(s) can be communicated to the third module 206 from the second module 204 for further transmission from the apparatus 102 for further processing so as to determine a suitable seat adjustment model usable for the preliminary adjustment stage of the seat(s). The suitable seat adjustment model can, for example, be determined based on the preliminary derivation signal(s) and the general adjustment signal(s) can be determined based on the suitable seat adjustment model. Moreover, the suitable seat adjustment model can be associated with one or more threshold values and the sensor(s) can be configured to communicate one or more fine-tuning sensory signal(s) obtained subsequent to the preliminary adjustment stage. The fine-tuning sensory signal(s) can be associated with real-time user data. The apparatus 102 can be configured to process the real-time user data and the threshold value(s) to derive delta data for use for secondary adjustment of the seat(s). Moreover, based on processing of the real-time user data and the threshold value(s) by the apparatus 102, one or more portions of the real-time user data can be determined to be either optimal or non-optimal. It is contemplated that delta data can, for example, be based only on non-optimal portions of the real-time user data. It is further contemplated that there is a possibility that the output signal(s) can, for example, be received by the host device(s) for machine-learning based processing.

As mentioned earlier, real-time user data required for further processing for the purpose of generating the requisite fine-tuning control signal(s) can effectively be considered to be streamlined/trimmed. In this manner, efficient processing can be facilitated. Moreover, since real-time user data required for further processing can effectively be streamlined/trimmed (i.e., not the entire real-time user data need to be considered for further processing), the present disclosure further contemplates that adjustment can be completed in a more time-efficient manner.

The above-described advantageous aspect(s) of the apparatus 102 of the present disclosure can also apply analogously (all) the aspect(s) of a below described processing method 300 of the present disclosure. Likewise, all below described advantageous aspect(s) of the processing method 300 of the disclosure can also apply analogously (all) the aspect(s) of above described apparatus 102 of the disclosure. It is to be appreciated that these remarks apply analogously to the earlier discussed system 100 of the present disclosure.

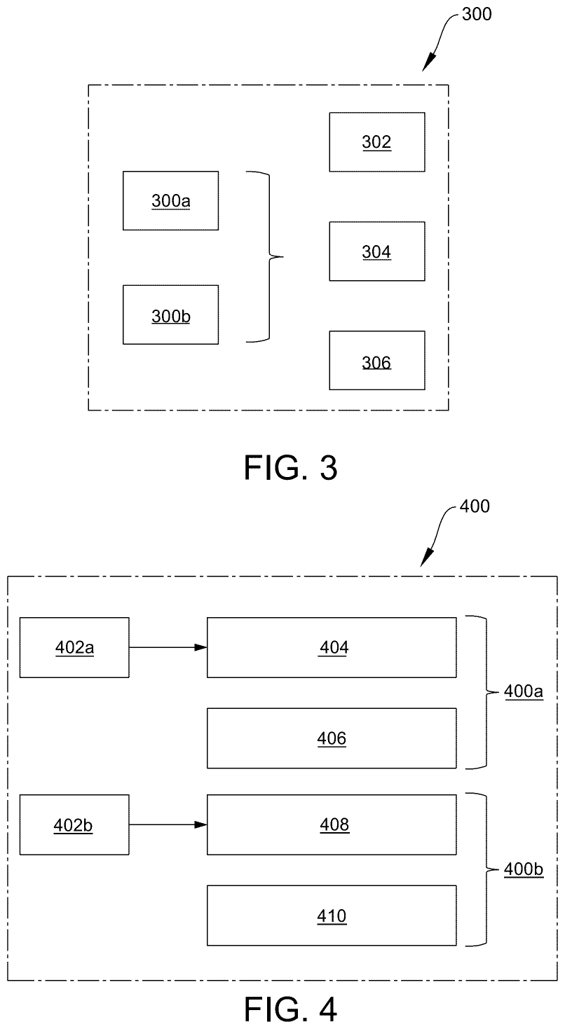

Referring to FIG. 3, a processing method 300 in association with the system 100 is shown, according to an embodiment of the disclosure.

The processing method 300 can associated with the aforementioned two-stage adjustment mechanism/strategy of seat(s). Specifically, in one embodiment, the processing method can include a preliminary adjustment step 300a and a secondary adjustment step 300b. The preliminary adjustment step 300a can correspond to the aforementioned preliminary adjustment stage of the seat(s) whereas the secondary adjustment step 300b can, for example, correspond to the aforementioned secondary adjustment stage of the seat(s).

The preliminary adjustment step 300a and the secondary adjustment step 300b can be based on any one of an acquisition step 302, a processing step 304 and an output generating step 306, or any combination thereof.

In one embodiment, the preliminary adjustment step 300a and the secondary adjustment step 300b can be based on an acquisition step 302, a processing step 304 and an output generating step 306.

With regard to the acquisition step 302, the input signal(s) can be received by the apparatus(es) 102.

With regard to the processing step 304, the input signal(s) can be processed by the apparatus(es) 102 in a manner so as to generate the output signal(s).

With regard to the output step 306, the output signal(s) can be communicated from the apparatus(es) 102.

In this regard, the present disclosure generally contemplates, in one embodiment, a processing method 300 which can be suitable for adjustment of one or more seats (e.g., one or more seats in a vehicle).

The processing method 300 can include a preliminary adjustment step 300a and a secondary adjustment step 300b.

The preliminary adjustment step 300a can include:
obtaining one or more preliminary sensory signals from one or more sensors positioned relative to the seat(s)
generating one or more general control signals by manner of determining a suitable seat adjustment model based on the preliminary sensory signal(s)

The general control signal(s) can be communicated for use for preliminary adjustment of the seat(s).

For example, the preliminary sensory signal(s) can be received by the first module 202 of the apparatus 102 and the general control signal(s) can be generated by the second module 204 of the apparatus 102, in accordance with an embodiment of the disclosure.

The secondary adjustment step 300b can include:
obtaining one or more fine-tuning sensory signals from the sensor(s)
determining delta data based on the fine-tuning sensory signal(s) and the suitable seat adjustment model
generating one or more fine-tuning control signals based on the delta data

The fine-tuning control signal(s) can be communicated for use for secondary adjustment of the seat(s).

For example, the fine-tuning sensory signal(s) can be received by the first module 202 of the apparatus 102, the delta data can be determined by the second module 204 of the apparatus 102 and the fine-tuning control signal(s) can be generated by the second module 204 of the apparatus 102, in accordance with an embodiment of the disclosure.

In one embodiment, the suitable seat adjustment model can be associated with one or more threshold values. The sensor(s) can be configured to communicate one or more fine-tuning sensory signals obtained subsequent to the preliminary adjustment stage. The fine-tuning sensory signal(s) can be associated with real-time user data. Moreover, the real-time user data and the threshold value(s) can be processed (e.g., by the apparatus(es) 102) to derive delta data for use for secondary adjustment of the seat(s). It is contemplated that one or more portions of the real-time user data can be determined to be either optimal or non-optimal. It is further contemplated that delta data can, for example, be based only on the non-optimal portion(s) of the real-time user data.

The present disclosure further contemplates a computer program (not shown) which can include instructions which, when the program is executed by a computer (not shown), cause the computer to carry out the preliminary adjustment step and the secondary adjustment step as discussed with reference to the processing method 300.

The present disclosure yet further contemplates a computer readable storage medium (not shown) having data stored therein representing software executable by a computer (not shown), the software including instructions, when executed by the computer, to carry out the preliminary adjustment step and the secondary adjustment step as discussed with reference to the processing method 300.

As mentioned earlier, real-time user data required for further processing for the purpose of generating the requisite fine-tuning control signal(s) can effectively be considered to be streamlined/trimmed. In this manner, efficient processing can be facilitated. Moreover, since real-time user data required for further processing can effectively be streamlined/trimmed (i.e., not the entire real-time user data need to be considered for further processing), the present disclosure further contemplates that adjustment can be completed in a more time-efficient manner.

Referring to FIG. 4, an example flow diagram 400 in association with the processing method 300 is shown, in accordance with an embodiment of the disclosure.

The example flow diagram 400 can include a first part 400a and a second part 400b. The first part 400a can be associated with the preliminary adjustment step 300a and the second part 400b can be associated with the secondary adjustment step 300b.

In one example, the first part 400a can include obtaining the aforementioned sensor signal(s) 402a, obtaining a suitable seat adjustment model 404 and a first stage adjustment (of seat(s)) 406. The second part 400b can include obtaining the aforementioned sensor signal(s) 402b, deriving Delta Data 408 and second stage adjustment (of seat(s)) 410.

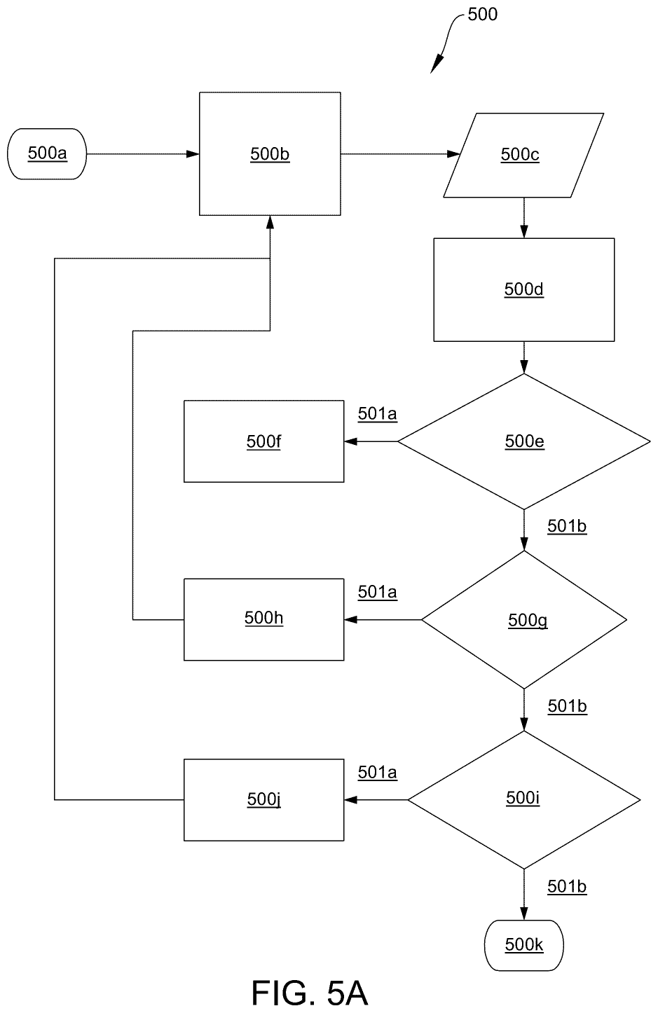

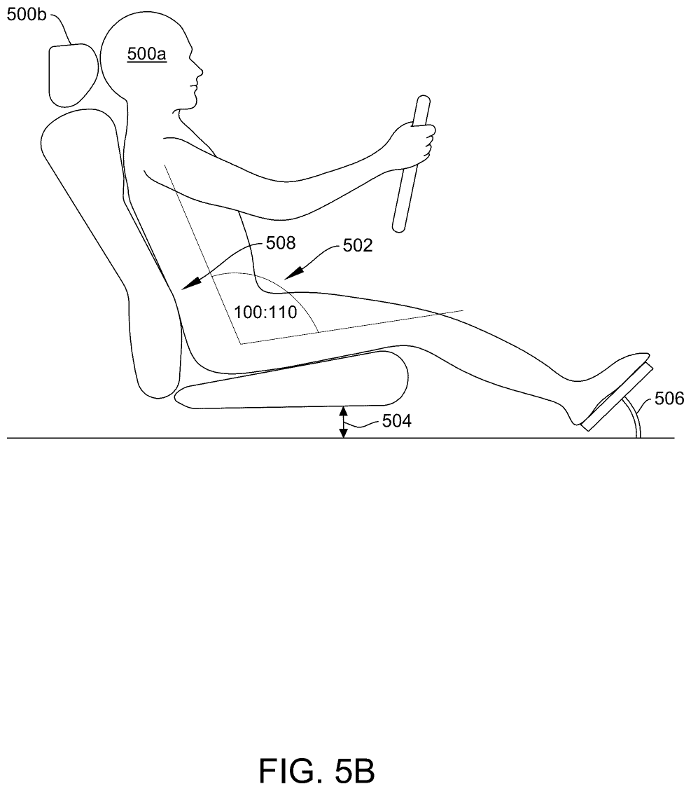

FIG. 5a and FIG. 5b respectively show, in association with the example flow diagram 400, an example scenario 500 in connection with a seat adjustment sequence and a driver 500a seated on a driver's seat 500b of an automobile (not shown), in accordance with an embodiment of the disclosure.

The example scenario 500 can begin (i.e., “start” 500a) and sensor(s) can be located at, for example, the vehicle interior (e.g., top/front view/window side/front driver display/driving or steering wheel) 500b.

Subsequent to “start” 500a, sensor signal(s) can be obtained 500c followed by the first and/or second stage adjustment 500d. It is then determined whether the driver seat is back to normal position (e.g., based on 100-110 degrees according to a driver lumbar) 500e. If “no” 501a, the driver seat is (automatically) adjusted based on driver lumbar 500f. If “yes” 501b, it is then determined whether the driver view height fulfils driving view 500g. If “no” 501a, the driver seat height is (automatically) adjusted 500h. If “yes” 501b, it is then determined whether the driver front view fulfils driving view 500i. If “no” 501a, the driver seat front distance is (automatically) adjusted 500j. If “yes” 501b, the seat adjustment sequence can be considered to have been concluded (i.e., “end” 500k).

Other seat adjustment sequence examples can be useful.

For example:

Example sequence 1: Adjust seat back position 502 followed by driver seat height 504 followed by front distance to the paddle 506 followed by top front mirror (not shown).

Example sequence 2: Adjust front distance to the paddle 506 followed by seat back position 502 followed by driver seat height 504 followed by top front mirror (not shown).

Additionally, the present disclosure contemplates that adjustment of seat can include adjusting a driver seat back 502 to about 100-110 degrees according to a driver lumbar 508.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, the present disclosure contemplates that a user of can be able to select an auto seat adjustment based a previously saved model.

In another example, the present disclosure contemplates that a user can abort adjustment at any time and perform manual adjustment for further fine-tuning if desired.

In yet another example, the present disclosure contemplates that a user can have the option of selecting/performing an auto seat adjustment based on short/medium/long distance travel. It is contemplated that a, for example, driver may require differing adjustment(s) depending on the manner in which the driver drives during short/medium/long travel. For example, the sensor(s) can be configured to monitor driver status and perform minor adjustment(s) if necessary.

In yet a further example, it can be appreciated that the host device(s) and the apparatus(es) 102 can be integrated (i.e., as a single device or as different portions of a hardware module) or separated (i.e., the host device(s) can be different hardware device(s) from the apparatus(es) 102).

In yet another further example, the real-time user data and the threshold value(s) can be processed by manner of machine-learning based processing (e.g., at the host device(s)) so as to derive delta data.

In yet another further additional example, it is contemplated that the communication network 106 can possibly be omitted. Communication between the apparatus(es) 102, the device(s) 104 and/or the host device(s) can be by manner of direct device-to-device based communication (e.g., IR (Infra-red) and/or Bluetooth-based communication). In yet another example, the apparatus(es) 102 and the device(s) can be coupled by manner of wired coupling (i.e., hence a communication network 106 can possibly be omitted for the purpose of communication as between the apparatus(es) 102 and the device(s) 104).

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. An apparatus for adjustment of at least one seat based on a two-step adjustment strategy comprising a preliminary adjustment stage and a secondary adjustment stage, the apparatus comprising:
a first module configurable to:
receive at least one input signal, the at least one input signal comprising:
at least one sensor signal communicable from at least one sensor positioned relative to the apparatus; and
at least one general adjustment signal communicable from at least one host device coupled to the apparatus,
a second module coupled to the first module, the second module configurable to process the at least one input signal in a manner so as to produce at least one output signal, the at least one output signal comprising:
at least one preliminary derivation signal based on processing of the at least one sensor signal,
at least one general control signal based on the at least one general adjustment signal, and
at least one fine-tuning control signal,
the at least one general control signal being usable for the preliminary adjustment stage of the seat, and
the at least one fine-tuning control signal being usable for the secondary adjustment stage of the seat, and being based on receiving at least one sensor signal communicable from the sensor subsequent to the preliminary adjustment stage.

2. The apparatus of claim 1, the sensor signals including at least one preliminary sensory signal and at least one fine-tuning sensory signal, the preliminary sensory signals being associable with the preliminary adjustment stage and the fine-tuning sensory signals being associable with the secondary adjustment stage,
wherein the second module is configurable to process the preliminary sensory signals to generate the preliminary derivation signals, and
wherein the preliminary derivation signals are processable so as to obtain a suitable seat adjustment model, the general adjustment signals being based on the suitable seat adjustment model.

3. The apparatus according to claim 2, wherein the sensor signals communicable from the sensor subsequent to the preliminary adjustment stage correspond to the fine-tuning sensory signals.

4. The apparatus according to claim 2,
wherein the suitable seat adjustment model is associable with at least one threshold value,
wherein the fine-tuning sensory signals are associable with real-time user data, and
wherein the apparatus is configurable to process the real-time user data and the threshold value to derive delta data for use for secondary adjustment of the seat.

5. The apparatus according to claim 4,
wherein the real-time user data include a plurality of portions, and
wherein based on processing of the real-time user data and the threshold value by the apparatus, a portion of the real-time user data is determinable to be one of optimal and non-optimal, and delta data being based only on non-optimal portions of the real-time user data.

6. The apparatus according to claim 1, further comprising:
a third module coupled to the second module, the output signals being communicable to the third module from the second module for further transmission from the apparatus for further processing so as to determine a suitable seat adjustment model usable for the preliminary adjustment stage of the seat,
wherein the suitable seat adjustment model is determinable based on the preliminary derivation signals, and
the general adjustment signals being determinable based on the suitable seat adjustment model.

7. The apparatus according to claim 6,
wherein the suitable seat adjustment model is associable with at least one threshold value,
wherein the sensor is configurable to communicate at least one fine-tuning sensory signal obtained subsequent to the preliminary adjustment stage, the fine-tuning sensory signals being associable with real-time user data,
wherein the apparatus is configurable to process the real-time user data and the threshold value to derive delta data for use for secondary adjustment of the seat, and
wherein based on processing of the real-time user data and the threshold value by the apparatus, a portion of the real-time user data is determinable to be one of optimal and non-optimal, delta data being based only on non-optimal portions of the real-time user data.

8. The apparatus according to claim 7, wherein the output signals are receivable by the host device for machine-learning based processing.

9. The apparatus according to claim 1, suitable for use for adjustment of at least one seat of an automobile, the seat being a driver seat.

10. A processing method for adjustment of at least one seat in a vehicle, the processing method comprising:
a preliminary adjustment step comprising:
obtaining at least one preliminary sensory signal from at least one sensor positioned relative to the seat, and
generating at least one general control signal by determining a suitable seat adjustment model based on the at least one preliminary sensory signal,
the at least one general control signal being communicable for use for preliminary adjustment of the seat; and
a secondary adjustment step comprising:
obtaining at least one fine-tuning sensory signal from the sensor;
determining delta data based on the at least one fine-tuning sensory signal and the suitable seat adjustment model, and
generating at least one fine-tuning control signal based on the delta data,
the at least one fine-tuning control signal being communicable for use for secondary adjustment of the seat.

11. The processing method according to claim 10,
wherein the suitable seat adjustment model is associable with at least one threshold value, and
wherein the sensor is configurable to communicate at least one fine-tuning sensory signal obtained subsequent to the preliminary adjustment stage, the fine-tuning sensory signals being associable with real-time user data.

12. The processing method according to claim 11, the real-time user data and the threshold value being processed to derive delta data for use for secondary adjustment of the seat,
wherein a portion of the real-time user data is determinable to be one of optimal and non-optimal, delta data being based only on non-optimal portions of the real-time user data.

13. (canceled)

14. A non-transitory computer readable storage medium having data stored therein representing software executable by a computer, the software including instructions, which when executed by the computer, carry out the preliminary adjustment step and the secondary adjustment step according to the processing method of claim 10.

15. The non-transitory computer readable storage medium according to claim 14,
wherein the suitable seat adjustment model is associable with at least one threshold value, and
wherein the sensor is configurable to communicate at least one fine-tuning sensory signal obtained subsequent to the preliminary adjustment stage, the fine-tuning sensory signals being associable with real-time user data.

16. The non-transitory computer readable storage medium according to claim 15,
the real-time user data and the threshold value being processed to derive delta data for use for secondary adjustment of the seat,
wherein a portion of the real-time user data is determinable to be one of optimal and non-optimal, delta data being based only on non-optimal portions of the real-time user data.
